(19) United States
(12) Patent Application Publication
(10) Pub. No.: US 2020/0232880 A1
(43) Pub. Date: Jul. 23, 2020

(54) METHOD AND DEVICE FOR SEARCHING FOR A DEFECT CAPABLE OF AFFECTING A ROTATING MECHANICAL POWER TRANSMISSION DEVICE

(71) Applicant: SAFRAN, Paris (FR)

(72) Inventors: Axel BARRAU, Moissy-Cramayel (FR); Elisa HUBERT, Moissy-Cramayel (FR); Mohamed EL BADAOUI, Moissy-Cramayel (FR)

(73) Assignee: SAFRAN, Paris (FR)

(21) Appl. No.: 16/634,028

(22) PCT Filed: Jul. 23, 2018
(86) PCT No.: PCT/FR2018/051886

§ 371 Date: Jan. 24, 2020

(30) Foreign Application Priority Data
Jul. 27, 2017 (FR) 17 57165

(51) Int. Cl. G01M 13/028; G01M 1/22; F16H 57/01; G06F 17/14; G06F 17/16

(52) U.S. Cl. CPC G01M 13/028; G01M 1/22; F16H 2057/012; G06F 17/141; G06F 17/16; F16H 57/01

(57) ABSTRACT

A method of searching for a defect capable of affecting a rotating mechanical power transmission device includes a step of obtaining a signal s that can be modeled by a product of a high frequency signal s1 and a low frequency signal s2, generated by the rotating mechanical power transmission device and acquired by a sensor, a step of determining estimates of the signals s1 and s2, minimizing a difference between all or part of the signal s and a product of these estimates, a step of analyzing the estimates of the signals s1 and s2 in order to detect the presence of a defect affecting the rotating power transmission mechanical device, and, if a defect is detected, a step of locating said defect from at least one of the estimates of the signals s1 and s2.

### BACKGROUND OF THE INVENTION

The invention relates to the general field of health monitoring of rotating mechanical machines, such as in particular rotating mechanical machines commonly used in the aeronautical industry.

It relates more particularly to the search for defects (e.g. wear, crack, etc.) likely to affect a rotating mechanical power transmission device (e.g. gear, ball bearing, motor, etc.), from signals (e.g. vibratory, acoustic or instantaneous speed signals) generated by this mechanical device during use thereof.

At present, the maintenance of the rotating mechanical power transmission devices such as those used in aeronautics is mainly based on a visual and endoscopic inspection of these devices. When designing these devices, a number of operating hours (e.g. flight hours when the device is installed in an aircraft) after which a maintenance is recommended, is calculated by taking into account relatively large safety margins. This approach however suffers from several shortcomings.

Indeed, a rotating device in perfect condition can be disassembled for verification and then be inappropriately or inaccurately reassembled. Conversely, such an approach does not allow rapidly detecting a rotating device that would have deteriorated shortly after its assembly, which could endanger the users of the system in which it is installed.

In addition, a visual and endoscopic inspection as it is currently practiced is a relatively long and tedious operation, which mobilizes for a significant time the system (e.g. aircraft engine) in which the device is installed. This inspection also depends on an operator, and can therefore be a source of errors.

To overcome these drawbacks and in particular to allow accurate and early detection of defects likely to affect a rotating machine, it is known, for ensuring the health monitoring of such a machine, to resort to vibration monitoring of the machine. The vibrations (or vibratory signals) generated by such a rotating machine during its operation represent indeed a very relevant signature of its state of health, instantly reflecting any change affecting its structure or its operating speed. These signals can be acquired from sensors positioned on or in the vicinity of the monitored rotating machines, such as for example accelerometers, etc.

The vibration monitoring is therefore particularly effective for the detection of defects or malfunctions affecting the rotating machines. To this end, it is conventionally based on the analysis of standard indicators extracted from the vibratory signals generated by the rotating machines such as, for example, their peak-to-peak amplitude, their power, their statistical moments or even the amplitude of their harmonics.

A major issue in the vibratory monitoring techniques today lies in the location of detected defects, in particular when the rotating machine of interest is a system composed of several rotating elements. The separation, in the acquired vibratory signal, of the contributions of the different elements advantageously allows easily locating the defect detected on the rotating machine.

The document by C. Capdessus et al. entitled “Analysis of the vibrations of a gear: cepstrum, correlation, spectrum”, Signal Processing, vol. 8 no. 5, shows that a rotating device such as a gear composed of two toothed wheels rotating at relatively close rotational speeds generates a vibratory signal which can be modeled as the product of two periodic signals (i.e. functions), and more particularly of a first “high-frequency” signal or component representing the meshing and of a second “low-frequency” signal or component representing the sum of the contributions of the two toothed wheels of the gear.

Based on this observation, a vibration monitoring method known in the state of the art applied to such a gear consists in filtering, by means of a band-pass filter, the spectrum of the vibratory signal generated by the gear around the gear meshing frequency (preferably around the dominant harmonic concentrating the most energy). The spectrum thus obtained is then brought back around the zero frequency. The time signal corresponding to the spectrum brought back around the zero frequency is proportional to the low-frequency component of the vibratory signal generated by the gear, in other words to the second signal representing the sum of the contribution of the two toothed wheels of the gear. The filtering of this signal proportional to the second signal allows extracting the contribution of each toothed wheel of the gear. Each contribution can then be analyzed separately, in particular by means of the aforementioned indicators (peak-to-peak amplitude, statistical moments, etc.), with a view to searching for the presence of a possible defect affecting the associated toothed wheel. It is noted that all of these operations are generally performed directly on the time signal.

This method is particularly effective when the energy of the vibratory signal is concentrated on a single harmonic. However, when several harmonics are visible in the spectrum of the vibratory signal, the band-pass filtering performed ignores a large part of the information carried by the vibratory signal. This results in inaccuracy in the indicators calculated and used to detect the defects, thus affecting the reliability of the detection carried out.

### OBJECT AND SUMMARY OF THE INVENTION

The main object of the present invention is to overcome the aforementioned drawbacks and proposes a method for searching for a defect likely to affect a rotating mechanical power transmission device, said mechanical device being an aircraft gear comprising two toothed wheels, comprising:

a step of obtaining a signal s which can be modeled by a product of a high-frequency signal s1 and of a low-frequency signal s2, generated by the rotating mechanical power transmission device and acquired by a sensor;

a step of determining estimates of the signals s1 and s2 minimizing a difference between all or part of the signal s and a product of these estimates, said determination step comprising:

a step (E22) of re-sampling a sequence derived from the signal s of a duration equal to an analysis duration, said analysis duration being an integer multiple of a period of the low-frequency signal s2, said sequence derived from the signal s being re-sampled with a regular pitch equal to a fraction of the analysis duration;

a step (E23) of obtaining a discrete Fourier transform of the re-sampled sequence, said discrete Fourier transform comprising a plurality of harmonics;

a step (E24) of constructing a matrix M(S) from the discrete Fourier transform obtained, the dimensions of the matrix depending on a number of harmonics determined for the signal s1 and on a number of harmonics determined for the signal s2, each component of the matrix comprising an amplitude of a harmonic of the discrete Fourier transform obtained;

a step (E25) of performing a rank 1 approximation of the matrix M(S) and obtaining discrete Fourier transforms of the estimates of the signals s1 and s2;

a step of analyzing the estimates of the signals s1 and s2 with a view to detecting the presence of a defect affecting the rotating mechanical power transmission device;

if a defect is detected at the end of the analysis step, a step of locating said defect from the at least one of the estimates of the signals s1 and s2.

Correlatively, the invention relates to a device for searching for a defect likely to affect a rotating mechanical power transmission device, said mechanical device being an aircraft gear comprising two toothed wheels, the search device comprising:

an obtaining module, configured to obtain a signal s which can be modeled by a product of a high-frequency signal s1 and of a low-frequency signal s2, generated by the rotating mechanical power transmission device and acquired by a sensor;

a determination module, configured to determine estimates of the signals s1 and s2 by minimizing a difference between all or part of the signal s and a product of these estimates, said determination module being configured to:

re-sample a sequence derived from the signal s of a duration equal to an analysis duration, said analysis duration being an integer multiple of a period of the low-frequency signal s2, said sequence derived from the signal s being re-sampled with a regular pitch equal to a fraction of the analysis duration;

obtain a discrete Fourier transform of the re-sampled sequence, said discrete Fourier transform comprising a plurality of harmonics;

construct a matrix M(S) from the discrete Fourier transform obtained, the dimensions of the matrix depending on a number of harmonics determined for the signal s1 and on a number of harmonics determined for the signal s2, each component of the matrix comprising an amplitude of a harmonic of the discrete Fourier transform obtained;

perform a rank 1 approximation of the matrix M(S) and obtain discrete Fourier transforms of the estimates of the signals s1 and s2;

an analysis module, configured to analyze the estimates of the signals s1 and s2 with a view to detecting the presence of a defect affecting the rotating mechanical power transmission device; and

a location module, activated if a defect is detected by the analysis module, configured to locate said defect from at least one of the estimates of the signals s1 and s2.

The invention also relates to a non-destructive control system for a rotating mechanical power transmission device, said mechanical device being an aircraft gear comprising two toothed wheels, the control system comprising:

a sensor configured to acquire a signal s which can be modeled by a product of a high-frequency signal s1 and of a low-frequency signal s2, and generated by the rotating mechanical power transmission device;

a device for searching a defect likely to affect the rotating mechanical power transmission device according to the invention, and configured to obtain and use the signal s acquired by the sensor.

The invention therefore proposes a vibration monitoring technique based on a demodulation of the signal s generated by the observed rotating mechanical device, while dispensing with band-pass filtering as made in the state of the art. It is noted that no limitation is attached to the nature of the signal s as long as it can be modeled in the form of a product of two high-frequency and low-frequency signals. The signal s can in particular be a vibratory signal, an acoustic signal or even an instantaneous speed signal.

To this end, the invention proposes to replace the filtering step implemented in the state of the art with an optimization step: this optimization step consists in minimizing the difference between all or part of the signal s generated by the rotating mechanical device, and which can be modeled by the product of two signals s1 and s2, and a product of the estimates of the signals s1 and s2. The estimates of the signals s1 and s2 thus obtained at the end of the optimization step allow better reconstruction of the signal s acquired by the sensor. From the estimates obtained from the signals s1 and s2 during the optimization step, the contribution of each element of the rotating mechanical device in the signal s acquired can then be easily and more accurately identified, allowing easy location on the at least one of these elements of the defect(s) detected, if need be, on the device.

The implementation of an optimization step overcoming a filtering of the signal according to the invention advantageously allows utilizing all the useful information contained in the vibratory signal s and leads to a very accurate estimate of the signals s1 and s2. The invention thus provides an accurate and reliable monitoring technique which can be easily applied to any type of rotating mechanical power transmission device as long as the signals (for example the vibratory or acoustic or instantaneous speed signals) generated thereby can be modeled by the product of a low-frequency signal and of a high-frequency signal as mentioned above. Such a rotating mechanical device is typically a gear formed of two toothed wheels as described above, but the invention also applies to other types of rotating mechanical power transmission devices, such as for example to an asynchronous thermal or electric motor, to a ball bearing, etc.

It should be noted that the monitoring technique proposed by the invention advantageously requires the use of only one sensor to locate a defect detected, if need be, on the observed rotating mechanical device, which facilitates implementation thereof.

Taking into account, for the estimate of the signals s1 and s2, a sequence of the acquired signal s of duration equal to the analysis duration advantageously allows an implementation of the invention in real time.

In one particular embodiment, the search method according to the invention comprises:

a step of obtaining kinematic parameters of the rotating mechanical power transmission device;

a step of determining, from said kinematic parameters, the duration of analysis of the signal s.

The use of a sequence of a duration which is an integer multiple of a period of the low-frequency signal s2 allows obtaining a spectrum having several harmonics around each of which there is a series of more or less spread out “peaks” corresponding to the spectrum of the low-frequency signal s2. This form of the spectrum can be easily utilized during the optimization step implemented by the invention. However, such a spectrum can be advantageously obtained in this embodiment even if the analysis duration is chosen to be relatively short (for example equal to twice the period of the low-frequency signal), which makes a real-time implementation of the search method proposed by the invention possible.

According to the invention, the search method further comprises a step of re-sampling the sequence derived from the vibratory signal with a regular pitch equal to a fraction of the analysis duration, before using it to determine the estimates of the signals s1 and s2.

This re-sampling step advantageously allows obtaining series of peaks around each harmonic of the spectrum which are in the form of series of diracs. The information contained in these series of diracs can therefore be more easily utilized (the peaks are not spread out by edge effect) and allows improving the accuracy of the estimation of the signals s1 and s2 carried out by the invention.

Furthermore, the search method comprises, during the step of determining the estimates of the signals s1 and s2:

a step of obtaining a discrete Fourier transform (or DFT) of the re-sampled sequence derived from the signal s, this discrete Fourier transform comprising a plurality of harmonics;

a step of constructing a matrix M(S) from the discrete Fourier transform obtained, the dimensions of the matrix depending on a number of harmonics determined for the signal s1 and on a number of harmonics determined for the signal s2, each component of the matrix comprising an amplitude of a harmonic of the discrete Fourier transform obtained;

a step of performing a rank 1 approximation of the matrix M(S) and obtaining discrete Fourier transforms of the estimates of the signals s1 and s2.

The invention offers a very simple way to implement the optimization step allowing the determination of the estimates of the signals s1 and s2, without loss of useful information. Such an optimization is indeed a non-linear and non-quadratic problem under constraints which can prove difficult to solve, in particular in an embedded and real-time context. Thanks to the step of re-sampling the acquired signal s and to the rearrangement of the re-sampled spectrum in matrix form (i.e. in the form of the matrix M(S)), this optimization problem can be reduced to an optimal rank 1 approximation which can be easily solved.

To perform the rank 1 approximation of the matrix M(S), different techniques can be used.

Thus, in one particular embodiment:

the step of performing a rank 1 approximation of the matrix M(S) uses a decomposition into singular values of the matrix M(S), said decomposition providing a first left singular vector of the matrix M(S), a first right singular vector of the matrix M(S) and a first singular value of the matrix M(S); and

the discrete Fourier transform of the estimate of the signal s1 is obtained from the first left singular vector of the matrix M(S) and the discrete Fourier transform of the estimate of the signal s2 is obtained from the first right vector of the matrix M(S), either of both of the first left or right singular vectors being weighted, a product of the applied weights being equal to the first singular value of the matrix M(S).

It is noted that, within the meaning of the invention, the estimates of the signals s1 and s2 determined during the determination step are not necessarily determined in the time domain, but can be determined in the frequency domain. Thus, the discrete Fourier transforms of the estimate of the signal s1 and of the estimate of the signal s2 constitute estimates of the signals s1 and s2 within the meaning of the invention, considering the known relation linking a time signal to its spectrum and more specifically to its discrete Fourier transform. It is therefore not necessary, for carrying out the analysis of the estimates of the signals s1 and s2 and the search for defects affecting the rotating mechanical device, to return into the time domain by transforming, via for example an inverse Fourier transform, the discrete Fourier transforms obtained during the obtaining step.

In addition, the spectra considered and obtained are not necessarily complete. They can be partial and comprise only the frequencies useful for the invention (typically the harmonics of the signal s1 and its modulations by the harmonics of the signal s2). Within the meaning of the invention, the term spectrum includes these different configurations (full or only partial spectrum).

Thus, in one particular embodiment, the step of analyzing the estimates of the signals s1 and s2 is carried out directly from the Fourier transforms of the estimates of the signals s1 and s2 obtained during the obtaining step.

In one alternative embodiment, the step of determining the estimates of the signals s1 and s2 further comprises a step of transforming, in the time domain, the discrete Fourier transforms obtained from the estimates of the signals s1 and s2.

The choice to directly analyze the estimates of the signals s1 and s2 in their time forms or in their frequency forms depends on the indicators considered to search for the defects likely to affect the rotating device.

In one particular embodiment, the search method comprises at least one step of filtering the signal s2 making it possible to identify contributions to the vibratory signal of different elements of the mechanical device, said identified contributions being used during the step of locating a defect detected at the end of the analysis step.

This step allows, from the signal s2, isolating the contribution of each element of the rotating device likely to be affected by a defect and facilitating the location of this defect. Each contribution thus isolated is analyzed independently of the other contribution (by calculating for example the indicators mentioned previously on this contribution), with a view to detecting whether it presents an anomaly. If need be, the location of a defect on the element corresponding to the analyzed contribution is direct.

As mentioned above, the invention applies to the search for defects affecting an aircraft gear comprising two toothed wheels, but it can also be applied to any type of rotating mechanical power transmission device, as long as the vibratory signals generated by these devices can be modeled in the form of a product of a low-frequency signal and of a high-frequency signal. The invention thus has a preferred but non-limiting application in the field of aeronautics which uses numerous rotating devices verifying this hypothesis, such as for example gears comprising two toothed wheels, ball bearings, etc., in particular equipping aircrafts and more particularly aircraft engines.

In one particular embodiment, the steps of the search method according to the invention are determined by computer program instructions.

Consequently, the invention also relates to a computer program on an information or recording medium, this program being likely to be implemented in a search device or more generally in a computer, this program including instructions adapted to the implementation of the step of determining the non-destructive control method as described above.

This program can use any programming language, and be in the form of source code, object code, or intermediate code between source code and object code, such as in a partially compiled form, or in any other desirable form.

The invention also relates to information or recording medium readable by a computer, and including of computer program instructions as mentioned above.

The information medium can be any entity or device capable of storing the program. For example, the medium may include a storage means, such as a ROM, for example a CD ROM or a microelectronic circuit ROM, or a magnetic recording means, for example a floppy disc or a hard disc.

On the other hand, the information medium can be a transmissible medium such as an electrical or optical signal, which can be routed via an electrical or optical cable, by radio or by other means. The program according to the invention can be particularly downloaded on an Internet-type network.

Alternatively, the information medium can be an integrated circuit in which the program is incorporated, the circuit being adapted to execute or to be used in the execution of the method in question.

### BRIEF DESCRIPTION OF THE DRAWINGS

Other characteristics and advantages of the present invention will emerge from the description given below, with reference to the appended drawings which illustrate therefrom one exemplary embodiment devoid of any limiting character. In the figures:

FIG. 1 represents, in its environment, a non-destructive control system according to the invention, in one particular embodiment;

FIG. 2 represents the hardware architecture of a search device according to the invention, belonging to the non-destructive control system of FIG. 1;

FIG. 3 represents, in the form of a flowchart, the main steps of a search method according to the invention, as implemented by the search device of FIG. 2; and

FIGS. 4 and 5 represent examples of Fourier transforms of signals that can be used during the search method according to the invention.

### DETAILED DESCRIPTION OF THE INVENTION

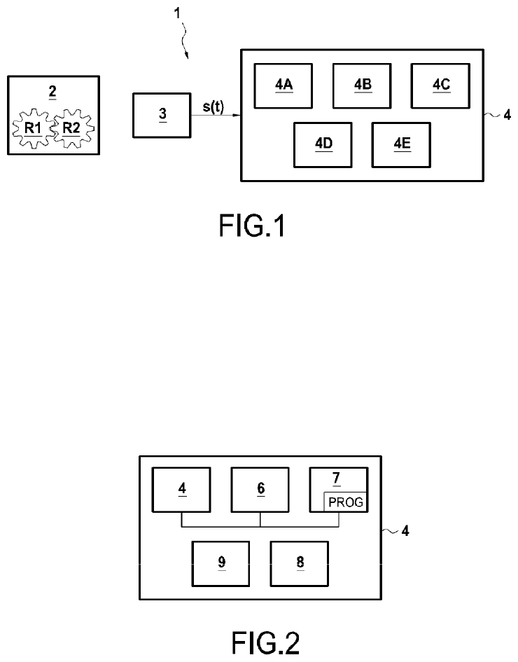

FIG. 1 represents, in its environment, a non-destructive control system 1 according to the invention, in one particular embodiment. The system 1 is configured to perform the non-destructive control of a rotating mechanical power transmission device 2. In the example envisaged in FIG. 1, the rotating mechanical device 2 is a gear composed of two toothed wheels R1 and R2 with spur teeth able to transmit power, such as those conventionally used in the aeronautical industry and which equip the aircraft engines.

The toothed wheels R1 and R2 are elements of the mechanical device 2 within the meaning of the invention. The toothed wheel R1 has an integer N1 of teeth, and the toothed wheel R2 has an integer N2 of teeth. N1 and N2 are assumed to be known. It is also assumed that the period Te of the meshing which separates, when the gear 2 is actuated, two consecutive teeth, is known.

It should be noted that the invention is not limited to this type of gears or even to gears, and can be applied to other rotating mechanical power transmission devices, such as for example to ball bearings, to asynchronous thermal or electric motors, etc.

In a known manner, such a rotating mechanical power transmission device generates, when actuated, a time signal noted s, of deterministic type, and whose parameters are linked to the kinematics of the rotating mechanical device. This signal s(t) is here a vibratory signal which can be modeled in the form of a product of a high-frequency signal noted s1 and of a low-frequency signal noted s2, namely:

s(t)=s1(t)×s2(t) (Eq. 1)

As a variant, signals other than vibratory signals can be envisaged since they can be modeled like the signal s in the form of a product of two signals s1 and s2. Thus, in particular, the signal s(t) can be an acoustic signal (reflecting the vibrations of the air generated by the rotating mechanical device) or an instantaneous speed signal measured by a sensor positioned on one of the shafts in rotation.

The high-frequency signal s1 is a periodic signal having the same frequency as the meshing. The low-frequency signal s2 can be written, in the example of the gear consisting of two toothed wheels R1 and R2 envisaged here, in the form:

s2(t)=1+sR1(t)+sR2(t) (Eq. 2)

where sR1(t) refers to a signal of the same frequency as the rotational frequency of the toothed wheel R1 and sR2(t) refers to a signal of the same frequency as the rotational frequency of the toothed wheel R2. In other words, the signal s1(t) is amplitude-modulated both by a periodic signal sR1(t) of period equal to the period of rotation of the toothed wheel R1 and by a periodic signal sR2(t) of period equal to the period of rotation of the toothed wheel R2.

Thus, schematically in this modeling, the signal s1(t) represents an “average” signal generated by the actuated gear, the signal sR1(t) represents a disturbance of the signal s1(t) caused by the defects (cracks, imperfections, etc.) affecting the toothed wheel R1 and the signal sR2(t) represents a disturbance of the signal s1(t) caused by the defects (cracks, imperfections, etc.) affecting the toothed wheel R2. The signals sR1(t) and sR2(t) characterize the contributions to the vibratory signal of the toothed wheels R1 and R2 within the meaning of the invention.

According to the invention, the non-destructive control system 1 performs a non-destructive control of the gear 2 from the vibratory signal s(t) generated thereby when it is actuated. To this end, it is equipped with a sensor 3, located in the vicinity of the gear 2 so as to measure and acquire the signal s(t). The sensor 3 is for example an accelerometer or a microphone. Its positioning in the vicinity of the gear 2 to allow it to acquire the vibratory signal generated by the latter poses no difficulty for those skilled in the art (it is placed for example as close as possible to a bearing supporting one of the axes of the wheels of the gear), and depends on the considered rotating mechanical device and on the context of use of the latter. It is not described in detail here.

The vibratory signal s(t) acquired by the sensor 3 is transmitted to a device 4 of the non-destructive control system 1 able to process this signal and to analyze it in particular with a view to detecting the presence of a possible defect on the gear 2. The device 4 is a device for searching a defect according to the invention.

In the embodiment described here, the search device 4 has the hardware architecture of a computer, as illustrated in FIG. 2. It comprises in particular a processor 5, a random access memory 6, a read-only memory 7, a non-volatile flash memory 8 as well as communication means 9 allowing in particular the search device 4 to communicate in particular with the sensor 3 to obtain the vibratory signal generated by the gear 2 and acquired by the latter. These communication means comprise for example a digital data bus if the search device 4 is on board the same equipment as the gear 2 (e.g. on board an aircraft), or a communication interface on a telecommunications network, etc.

The read-only memory 7 of the search device 4 constitutes a recording medium according to the invention, readable by the processor 5 and on which a computer program PROG is recorded according to the invention.

The computer program PROG defines functional and software modules here, configured to implement a method for searching for possible defects affecting the gear 2 according to the invention. These functional modules are based on and/or control the hardware elements 5-9 of the research device 4 mentioned above. They include in particular here, as illustrated in FIG. 1:

an obtaining module 4A, configured to obtain the vibratory signal s measured by the sensor 3 and generated by the actuated gear 2, this module being based on the communication means 9;

a determination module 4B, configured to determine estimates of the signals s1 and s2, the product of which minimizes a difference with the vibratory signal s;

an analysis module 4C, configured to analyze the estimates of the signals s1 and s2 determined by the determination module 4B with a view to detecting the presence of a defect affecting the rotating mechanical power transmission device; and

a 4D location module, activated if a defect is detected by the analysis module 4C, configured to locate said defect from at least one of the estimates of the signals s1 and s2.

In the embodiment described here, the search device 4 further has a notification module 4E, able to notify a user or a remote equipment of the existence of a defect on the gear if need be. This notification module 4E can be based in particular on the communication means 9 of the search device 4 or on input/output means thereof, such as for example a screen or a microphone able to signal the detection of a defect to a user installed in the vicinity of the search device 4.

The functions of these different modules are described in more detail now with reference to the steps of the research method according to the invention.

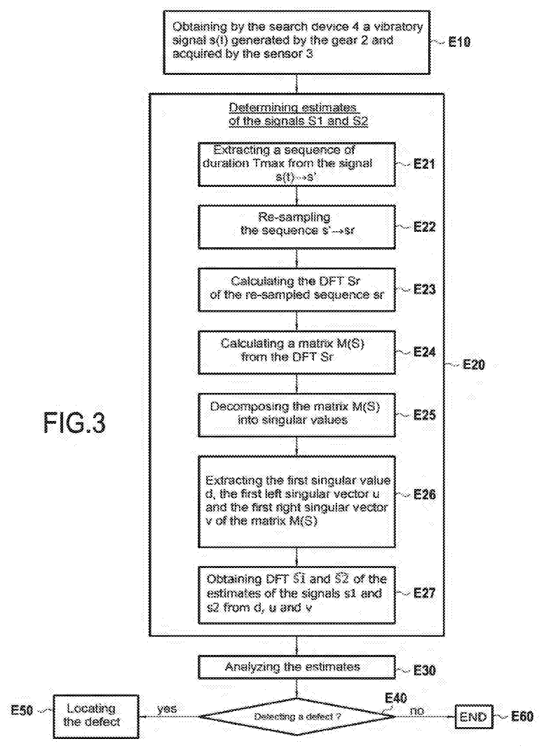

FIG. 3 illustrates, in the form of a flowchart, the main steps of a search method according to the invention in one particular embodiment in which it is implemented by the search device 4 of the non-destructive control system 1. It is assumed, as a preliminary to this method, that the gear 2 is actuated with a meshing period Te, and generates a vibratory signal s(t) as described above.

This vibratory signal s(t) is acquired by the sensor 3 over a predetermined measurement duration noted Tacq, and provided to the search device 4. The vibratory signal s(t) is here a sampled signal comprising a plurality Nech of samples corresponding to sampling instants tᵢ, . . . , t_{Nech} multiple of a sampling period Tech.

For example, Tacq is chosen equal to once the period of the low-frequency signal s2. As a variant, Tacq can be chosen equal to several periods of the low-frequency signal s2 to allow a filtering of the noise present in the signal.

The vibratory signal s(t) is obtained by the module 4A for obtaining the search device 4 via in particular the communication means 9 equipping the search device 4 (step E10). The obtaining module 4A provides the vibratory signal s(t) obtained to the determination module 4B for processing.

As mentioned previously, the vibratory signal s(t) generated by the gear 2 and acquired by the sensor 3 is remarkable in that it can be modeled as the product of a high-frequency signal s1 and of a low-frequency signal s2 (cf. equation (Eq. 1) above). By high-frequency signal and low-frequency signal, it is understood here that the high-frequency signal s1 is periodic and has a frequency higher than the low-frequency signal s2 which is also periodic. The low-frequency signal s2 also comprises, as shown in the equation (Eq. 2), the contribution sR1 due to the toothed wheel R1 and the contribution sR2 due to the toothed wheel R2. The processing of the vibratory signal s(t) by the determination module 4B consists in determining an estimate of each of the signals s1 and s2 in order to be able to analyze them to detect the presence, if need be, of a defect affecting the gear.

To this end, the determination module 4B, unlike the processing known in the state of the art, does not perform a sub-optimal band-pass filtering around the meshing frequency of the gear to extract the low-frequency signal s2. But it determines the estimates of the signals s1 and s2 (noted respectively and by minimizing a difference between the vibratory signal s(t) and the product of these estimates, namely by solving the following optimization problem (step E20):

( [symbol] , [symbol] )=argmin_{(s̅1̅,s̅2̅)}(Σₙ^{NS}∥s(tₙ)−s̅1̅(tₙ)s̅2̅(tₙ)∥²) (Eq. 4)

where the estimates of the signals s1 and s2 are sought on the set of the periodic functions of period Te and T2 respectively.

The inventors have found that, in a particularly advantageous embodiment, this optimization problem could be solved very simply via a matrix processing with some simple preprocessing operations carried out on the vibratory signal s(t).

As a variant, other techniques for solving the optimization problem mentioned in the equation (Eq. 4) can be used by the determination module 4B, such as for example a gradient descent, a Newton or Gauss-Newton method, symbolic methods, an extended Kalman filter, a stochastic gradient descent, etc.

In the embodiment described here, in order to determine the estimates of the signals s1 and s2 in a simple manner, the determination module 4B first performs a re-sampling of the signal s(t) (step E21).

To this end, the determination module 4B firstly determines, from the kinematic parameters of the gear 2, and more particularly from the number N1 of teeth of the gear wheel N1, from the number N2 of teeth of the toothed wheel N2, and from the meshing period Te of the gear 2, a duration of analysis Tmax of the vibratory signal s(t).

It is assumed here that these kinematic parameters of the gear 2 have been communicated to the search device 4 beforehand, for example by an operator supervising the non-destructive control carried out by the non-destructive control system 1, and are stored for example in its non-volatile memory 8.

As a variant, these parameters can be obtained by the search device 4 by interrogating a user via the input/output means of the search device 4, or the search device 4 could have been configured beforehand with these parameters, in particular when it is on board and intended to operate in an autonomous manner without the intervention of an operator.

It is noted that the numbers of teeth N1 and N2 depend on the gear 2 and are therefore set and known in advance. The meshing period Te depends for its part on the engine speed: it can either be set in advance and imposed to the motor, or provided by an operator or a user as mentioned above, or even be evaluated by a complementary module provided to this end.

The analysis duration Tmax determined by the determination module 4B is taken here equal to a integer multiple Nmax of the period noted T2 of the low-frequency signal s2 (Nmax is an integer greater than or equal to 1), i.e. Tmax=Nmax×T2. For a gear consisting of two toothed wheels R1 and R2 as envisaged in FIG. 1, the period T2 of the low-frequency signal s2 is equal to:

T2=Ntot×Te

where Ntot refers to the smallest common multiple of N1 and N2.

The choice of Nmax depends of course on the duration Tacq of acquisition of the vibratory signal s(t) by the sensor 3 and on the context of application of the invention: it is indeed well understood that if a real-time application is desired, a small number Nmax will be chosen preferentially. Conversely, the larger Nmax is chosen, the lower the noise affecting the signal.

Then, the determination module 4 B extracts from the vibratory signal s(t) that has been transmitted thereto a sequence noted s′ of duration equal to the analysis duration Tmax (step E21). It then re-samples the sequence thus extracted with a regular pitch equal to a fraction of the duration of analysis Tmax (step E22), namely:

ΔT=Tmax/n (Eq. 3)

where n refers to a predetermined number of samples. This re-sampling is carried out using a standard interpolation technique, such as for example a linear interpolation technique, or a Whittaker-Shannon technique, etc. The re-sampled sequence obtained is noted sr.

The choice of the integer n results from a compromise: the larger n is chosen, the more the loss of information linked to the re-sampling is limited but the higher the calculation complexity linked to the re-sampling. Note however that it is useless to choose n greater than T2/Tech (Tech referring to the sampling period of the signal s) because there is then no more gain of information.

It is noted that if the considered re-sampling pitch is regular, it does not however necessarily remain constant over time: a pitch as defined by the equation (Eq. 3) indeed adapts advantageously to the speed of rotation of the wheels and of the meshing (i.e. the re-sampling carried out is an “angular” sampling, determined by the variation of angle of the wheels). If the wheels accelerate, the re-sampling pitch varies for a constant number n of samples.

Thanks to this re-sampling, and considering the characteristics of the vibratory signal s(t), it is ensured that the spectrum of the re-sampled sequence sr of duration Tmax extracted from the vibratory signal s(t) is composed of a series of harmonics corresponding to the high-frequency signal s1, each harmonic being surrounded by diracs corresponding to the pattern of the spectrum of the low-frequency signal s2. It is noted that in the absence of re-sampling, the diracs are replaced by more or less spread out “capitals”, which has the effect of introducing a noise that should be taken into account when processing the vibratory signal (for example by approximating each capital by a dirac).

The inventors had the judicious idea of using at the determination module 4B the re-sampled sequence sr as an approximate version of the vibratory signal s(t) to solve the optimization problem given by the equation (Eq. 4), and to utilize the property of the spectrum of this sequence set out above to simplify the resolution of the optimization problem.

Indeed, the equation (Eq. 4) can be written, in the spectral domain, in the form:

$$( , ) = {arg min}_{\overline{S 1} , \overline{S 2}} ( {‖ Sr - \frac{1}{n} \overline{S 1} * \overline{S 2} ‖}^{2} ) \qquad ( Eq . 5 )$$

where n refers to the number of samples previously introduced during the re-sampling step E22, and Sr, [symbol] , [symbol] refer respectively to the discrete Fourier transforms of the signals Sr, [symbol] and [symbol] , ∥∥refers to a Euclidean norm, and * to the convolution operator. A vector representation of the discrete Fourier transforms Sr, [symbol] , [symbol] and the following convention if E( ) refers to the function of the integer part are used here: the harmonic 0 is at the position E((n+1)/2) in the vector Sr, the harmonic 1 is at the position E((n+1)/2)+1, the harmonic −1 is at the position E((n+1)/2)−1, etc.

However, as all the signals, thanks to the re-sampling carried out during step E21, are in the spectral domain in the form of series of diracs, the convolution present in the equation (Eq. 5) includes “at each operation” only one term. The problem of optimizing the equation (Eq. 5) is thus equivalent to the problem defined by the following equation (Eq. 6):

$$( ) , ) ) = {arg min}_{\overline{M ( S 1 )} , \overline{M ( S 2 )}} ( {‖ M ( S ) - \frac{1}{n} \overline{M ( S 1 )} \cdot \overline{{M ( S 2 )}^{T}} ‖}_{Fro}^{2} ) \qquad ( Eq . 6 )$$

where M(S) refers to a matrix whose components correspond to the amplitudes of the diracs of the discrete Fourier transform Sr, [symbol] refers to a column vector whose components correspond to the amplitudes of the diracs of the discrete Fourier transform [symbol] (in other words it is the column vector obtained by deleting from the vector [symbol] the inputs that do not correspond to the harmonics of the signal s1), [symbol] refers to a column vector whose components correspond to the amplitudes of the diracs of the discrete Fourier transform [symbol] (in other words, it is the column vector obtained by deleting from the vector [symbol] the inputs that do not correspond to the harmonics of the signal s2), and ∥∥_{Fro} refers to the matrix Froebenius norm, known per se and not recalled here. The solution of the problem defined by the equation (Eq. 6) can be obtained in a known manner from the first singular value of the matrix M(S), as described in more detail below.

Thus, following the re-sampling carried out in step E22, the determination module 4B determines the discrete Fourier transform Sr of the re-sampled sequence sr (step E23).

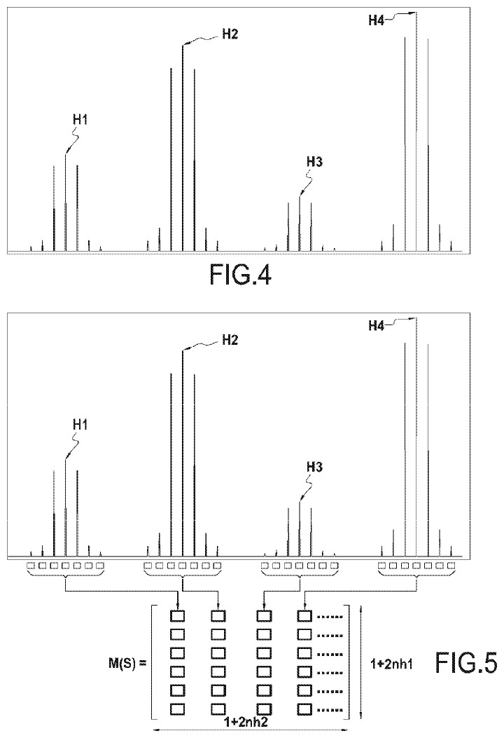

FIG. 4 illustrates the shape of the obtained Fourier transform Sr, in the absence of noise. Four harmonics H1, H2, H3 and H4 (corresponding to the harmonics of the high-frequency signal s1) are distinguished in this figure, each harmonic being surrounded on either side symmetrically by a set of diracs (three diracs in FIG. 4 present on each side of each harmonic). The sets of diracs located on either side of each harmonic of the high-frequency signal s1 correspond to the harmonics of the spectrum of the low-frequency signal s2.

From this obtained “spectrum” of diracs, the determination module 4B constructs a matrix M(S) (step E24) whose dimensions depend on an integer noted nh1 of harmonics determined for the high-frequency signal s1, and on an integer nh2 of harmonics determined for the low-frequency signal s2. In the embodiment described here, the matrix M(S) has (1+2nh1) lines and (1+2nh2) columns, the components of the matrix M(S) corresponding to the amplitudes of diracs selected in the discrete Fourier transform Sr.

The numbers of harmonics nh1 and nh2 considered for each of the signals s1 and s2 respectively depend on the type of rotating device considered, and a fortiori, on the type of gear considered in the example of FIG. 1. If a defect affects the considered gear, the number of harmonics present in the discrete Fourier transform Sr for the signals s1 and s2 may increase, and it is necessary to consider numbers nh1 and nh2 large enough not to lose information during the processing of the discrete Fourier transform Sr. On the contrary, the higher the quality of the vibratory signal generated by the gear, the fewer the harmonics in the discrete Fourier transform. The numbers nh1 and nh2 can be determined experimentally, by testing various gears affected by various defects.

The inventors have found, experimentally, that a number nh1 approximately equal to 10 and a number nh2 comprised between 8 and 12 corresponded to a good compromise for covering many gears, regardless of the number of teeth of the toothed wheels constituting these gears.

The positions of the different harmonics of the signals s1 and s2 in the discrete Fourier transform Sr are known from the kinematic parameters of the gear 2: they are located at the frequencies −h1.f1, (−nh1+1).f1, . . . ,f1, . . . ,nh1.ft1 for the harmonics of the signal s1, and around each of these frequencies at −nh2.f2, (−nh2+1).f2, . . . ,f2, . . . , nh2.f2 for the harmonics of the signal s2, the frequencies f1 and f2 of the signals s1 and s2 can be derived from the numbers of teeth N1 and N2 and from the meshing period Te according to the expressions:

f1=1/Te

and

f2=1/T2=f1/Ntot.

Knowing these positions, the determination module 4B constructs the matrix M(S) by associating with each component of the matrix the value of the amplitude of a dirac (harmonic) of the Fourier transform Sr, namely if M(S)[i,j] refers to the component of the matrix located at the intersection of the i^{th} line and of the j^{th} column, for i integer such that i=1,2, . . . ,2.nh1+1, and j integer such that j=1,2, . . . ,2.nh2+1:

M(S)[i,j]=Sr[N0+(N.(i−nh1−1)+Ntot(j−nh2−1)] (Eq.7)

with N0=E((n+1)/2) and N the integer verifying :

$$N = \frac{T max}{T e} = N max \cdot N tot$$

considering the previously introduced notations. The operation performed by the determination module 4B to construct the matrix M(S) is schematized in FIG. 5.

The determination module 4B then calculates a rank 1 approximation of the matrix M(S) (rank 1 approximation for the Frobenius norm here). The result of this approximation is a matrix whose all the columns are proportional to each other and which can be written in the form of a product of two terms [symbol] , [symbol] ^{T}, from which it is possible to derive estimations of the spectra of the signals s1 and s2.

Several approximation methods can be used for this purpose by the determination module 4B, such as for example an alternating-projection algorithm, an alternating-variable algorithm, or a complete decomposition into singular values. These methods can be adapted for a real-time operation.

In the embodiment described here, the determination module 4B uses, to perform a rank 1 approximation of the matrix M(S), a decomposition into singular values of the matrix M(S) (step E25). It obtains, at the end of this decomposition, three matrices U, D and V such that:

M(S)=UDV^{H}

^{H} referring to the Hermitian operator, U and V referring to unit matrices and D referring to a diagonal matrix comprising the singular values of the matrix M(S). The unit matrices U and V respectively contain the singular vectors called left singular vectors and the singular vectors called right singular vectors corresponding to the singular values contained in the diagonal matrix D.

According to such a decomposition (or SVD for “Singular Value Decomposition”), the singular values are ordered in the descending order in the matrix D. The determination module 4B then extracts from the matrix D, the first singular value noted d of the matrix M(S) (corresponding to the largest singular value of the matrix), and from the matrices U and V, the first left singular vector of the matrix M(S) noted u and the first left singular vector of the matrix M(S) noted v corresponding to the first singular value d (step E26).

Then it obtains from the singular value d and the vectors u and v two vectors representing two spectra:

[symbol]

=d.u

and

[symbol]

=v

and corresponding to estimations of the spectra of the signals s1 and s2 respectively. These two vectors actually contain the estimated harmonics of the signals s1 and s2.

The determination module 4B then estimates, from these two vectors, the discrete Fourier transforms [symbol] of one estimate of the signal s1 and [symbol] of one estimate of the signal s2 in the following manner (step E27): [symbol] [N0+i.N]= [symbol] [nh1+1+i]=d.u[nh1+1+i] for i=−nh1, . . . ,nh1

[symbol] [N0+i. Nmax]= [symbol] [nh2+1+i.Nmax]=v[nh2+1+i. Nmax] for i=−nh2, . . . ,nh2

where u[i], respectively v[i], refers to the i^{th} component of the vector u, respectively of the vector v. In other words, the spectrum [symbol] comprises 2.nh1+1 harmonics whose amplitudes are given to the singular value d by the components of the vector u, and the spectrum [symbol] comprises 2.nh2+1 harmonics whose amplitudes are given by the components of the vector v.

It is noted that a different convention can be applied by the determination module 4B to derive the discrete Fourier transforms [symbol] and [symbol] , namely that the singular value d being only a multiplicative value, it can be indifferently applied to the components of the vector v instead of the components of the vector u, namely:

[symbol] [N0+i.N]=u[nh1+1+i] for i=−nh1, . . . ,nh1 [symbol] [N0+i. Nmax]=d.v[nh2+1+i.Nmax] for i=−nh2, . . . ,nh2

It should be noted that the Fourier transforms thus obtained by the determination module 4B correspond to the discrete Fourier transforms of the estimates [symbol] and [symbol] of the signals s1 and s2 that allow an optimal reconstruction of the signal s from the product of the estimates [symbol] and [symbol] .

The determination module 4B provides the Fourier transforms [symbol] and [symbol] to the analysis module 4C of the search device 4 for analysis.

As a variant, the determination module 4B transforms the discrete Fourier transforms [symbol] and [symbol] in the time domain, using an inverse discrete Fourier transform, before transmitting them to the analysis module 4C. It then transmits to the analysis module 4C directly the estimates [symbol] and [symbol] of the signals s1 and s2.

The analysis module 4C then applies standard analysis techniques to the estimates of the signals s1 and s2 which have been transmitted thereto by the determination module 4B to detect whether a defect affects the gear 2 (step E30).

It can filter beforehand the estimate of the signal s2 so as to identify the contributions of each of the toothed wheels R1 and R2 (i.e. estimates of the previously introduced signals sR1 and sR2), then apply the abovementioned standards analysis techniques to each of the contributions thus identified. These techniques can be applied either directly on the spectral form of the estimates, or on their time form.

For example, during the analysis step E30, the analysis module 4C can estimate, from the identified contributions, standard failure indicators such as the kurtosis, the peak-to-peak amplitude or the relative amplitude of the harmonics, and compare these indicators with respect to a predetermined threshold (test step E40). The exceeding of the threshold by one of these failure indicators indicates the presence of a defect affecting the gear.

In addition, if this exceeding is detected on the contribution associated with the toothed wheel R1, the defect is located on the toothed wheel R1 (location step E50 within the meaning of the invention). Conversely, if this exceeding is detected on the contribution associated with the toothed wheel R2, the defect is located on the toothed wheel R2 (location step E50 within the meaning of the invention). This location allows a targeted and efficient maintenance of the gear.

In the particular embodiment described here, the defect detected, if need be, and its location, are notified by the search device via its notification module 4E to an operator in charge of maintenance of the gear 2. This notification can be done for example by sending a notification message to the operator or to a maintenance system, by displaying a message on a screen of the search device 4, etc.

The invention therefore proposes a very effective method for processing the vibratory signal derived from a gear, and more generally from a rotating mechanical power transmission device, spurious signals derived from the environment in which it is installed (e.g. aircraft engine), without resorting to complex source separation methods based on multiple sensors (as much as sources possible to separate), and without loss of information resulting from the implementation of a band-pass filtering. The contributions of the various elements of the rotating device to the vibratory signal (i.e. of the two wheels in the case of the gear considered in the example of FIG. 1) can be studied independently, which makes it possible to identify, if need be, the defective element.

It is noted that, although having been described with reference to a vibratory signal generated by the gear, the invention is applied in an identical manner to other types of signals such as for example to an acoustic or instantaneous speed signal.

1. A method for searching for a defect likely to affect a rotating mechanical power transmission device, said mechanical device being an aircraft gear comprising two toothed wheels, the method comprising:
a step of obtaining a signal s which can be modeled by a product of a high-frequency signal s1 and of a low-frequency signal s2, generated by the rotating mechanical power transmission device and acquired by a sensor;
a step of determining estimates of the signals s1 and s2 minimizing a difference between all or part of the signal s and a product of these estimates, said determination step comprising:
a step of re-sampling a sequence derived from the signal s of a duration equal to an analysis duration, said analysis duration being a integer multiple of a period of the low-frequency signal s2, said sequence derived from the signal s being re-sampled with a regular pitch equal to a fraction of the analysis duration;
a step of obtaining a discrete Fourier transform of the re-sampled sequence, said discrete Fourier transform comprising a plurality of harmonics;
a step of constructing a matrix M(S) from the discrete Fourier transform obtained, the dimensions of the matrix depending on a number of harmonics determined for the signal s1 and on a number d harmonics determined for the signal s2, each component of the matrix comprising an amplitude of a harmonic of the discrete Fourier transform obtained;
a step of performing a rank 1 approximation of the matrix M(S) and obtaining discrete Fourier transforms of the estimates of the signals s1 and s2;
a step of analyzing the estimates of the signals s1 and s2 with a view to detecting the presence of a defect affecting the rotating mechanical power transmission device;
if a defect is detected at the end of the analysis step, a step of locating said defect from the at least one of the estimates of the signals s1 and s2.

2. The search method according to claim 1 comprising:
a step of obtaining kinematic parameters of the rotating mechanical power transmission device;
a step of determining, from said kinematic parameters, said duration of analysis of the signal s, said analysis duration being a integer multiple of a period of the low-frequency signal s2.

3. The search method according to claim 1 wherein:
the step of performing a rank 1 approximation of the matrix M(S) uses a decomposition into singular values of the matrix M(S), said decomposition providing a first left singular vector of the matrix M(S), a first right singular vector of the matrix M(S) and a first singular value of the matrix M(S); and
the discrete Fourier transform of the estimate of the signal s1 is obtained from the first left singular vector of the matrix M(S) and the discrete Fourier transform of the estimate of the signal s2 is obtained from the first right vector of the matrix M(S), either or both of the first left or right singular vectors being weighted, a product of the applied weights being equal to the first singular value of the matrix M(S).

4. The search method according to claim 3, wherein the step of determining the estimates of the signals s1 and s2 further comprises a step of transforming, in the time domain, the discrete Fourier transforms obtained from the estimates of the signals s1 and s2.

5. The search method according to anyone of claim 1 comprising at least one step of filtering the signal s2 making it possible to identify contributions to the vibratory signal of different elements of the mechanical device, said identified contributions being used during the step of locating a defect detected at the end of the analysis step.

6. The search method according to anyone of claim 1, wherein the step of analyzing the estimates of the signals s1 and s2 is carried out from discrete Fourier transforms of the estimates of the signals s1 and s2.

7. A device for searching for a defect likely to affect a rotating mechanical power transmission device, said mechanical device being an aircraft gear comprising two toothed wheels, the search device comprising:
an obtaining module, configured to obtain a signal s which can be modeled by a product of a high-frequency signal s1 and of a low-frequency signal s2, generated by the rotating mechanical power transmission device and acquired by a captor;
a determination module, configured to determine estimates of the signals s1 and s2 by minimizing a difference between all or part of the signal s and a product of these estimates, said determination module being configured to:
re-sample a sequence derived from the signal s of a duration equal to an analysis duration, said analysis duration being an integer multiple of a period of the low-frequency signal s2, said sequence derived from the signal s being re-sampled with a regular pitch equal to a fraction of the analysis duration;
obtain a discrete Fourier transform of the re-sampled sequence, said discrete Fourier transform comprising a plurality of harmonics;
construct a matrix M(S) from the discrete Fourier transform obtained, the dimensions of the matrix depending on a number of harmonics determined for the signal s1 and on a number of harmonics determined for the signal s2, each component of the matrix comprising an amplitude of a harmonic of the discrete Fourier transform obtained;
perform a rank 1 approximation of the matrix M(S) and obtain discrete Fourier transforms of the estimates of the signals s1 and s2;
an analysis module, configured to analyze the estimates of the signals s1 and s2 with a view to detecting the presence of a defect affecting the rotating mechanical power transmission device; and
a location module, activated if a defect is detected by the analysis module, configured to locate said defect from at least one of the estimates of signals s1 and s2.

8. A non-destructive control system for a rotating mechanical power transmission device, said mechanical device being an aircraft gear comprising two toothed wheels, the control system comprising:
a sensor configured to acquire a signal s which can be modeled by a product of a high-frequency signal s1 and of a low-frequency signal s2, and generated by the rotating mechanical power transmission device;
a device for searching a defect likely to affect the rotating mechanical power transmission device according to claim 7 and configured to obtain and use the signal s acquired by the sensor.
